(19) United States
(12) Patent Application Publication
(10) Pub. No.: US 2025/0308760 A1
(43) Pub. Date: Oct. 2, 2025

(54) INDUCTOR AND DC-DC CONVERTER

(71) Applicant: TDK Corporation, Tokyo (JP)

(72) Inventors: Naoya HIEDA, Tokyo (JP); Hajime KUWAJIMA, Tokyo (JP); Tomofumi KURODA, Tokyo (JP)

(73) Assignee: TDK Corporation, Tokyo (JP)

(21) Appl. No.: 19/091,854

(22) Filed: Mar. 27, 2025

(30) Foreign Application Priority Data
Mar. 29, 2024 (JP) 2024-057845

(51) Int. Cl. H01F 27/32; H01F 27/255; H02M 3/155

(52) U.S. Cl. CPC H01F 27/324; H01F 27/255; H02M 3/155

(57) ABSTRACT

In the inductor and the DC-DC converter, the leveling of the amount of the adhesive material in the facing regions of the facing surfaces of the conductive portions is achieved by receiving a part of the adhesive material of the first region with the second region, even when the amount of the adhesive material provided in the first region is excessive. As a result, the relative positional relationship between the magnetic block and the conductive portion of the coil conductor is stabilized, and the inductance value is stabilized.

### CROSS-REFERENCE TO RELATED APPLICATION

This application is based upon and claims the benefit of priority from Japanese Patent Application No. 2024-057845, filed on Mar. 29, 2024, the entire content of which is incorporated herein by reference.

### TECHNICAL FIELD

The present disclosure relates to an inductor and a DC-DC converter.

### BACKGROUND

Japanese Patent Application Publication No. 2000-315610 discloses an inductor having a configuration where a coil conductor (electrode) and a magnetic block (magnetic core) are bonded by adhesive material.

### SUMMARY

An inductor according to one aspect of the present disclosure includes a magnetic block, a coil conductor aligned with the magnetic block in a first direction and extending in a second direction orthogonal to the first direction and including a first conductive portion having a facing surface including a facing region facing the magnetic block in the first direction, a resin material interposed between the magnetic block and the facing region of the facing surface of the first conductive portion of the coil conductor. The facing region of the facing surface of the first conductive portion includes a first region and a second region, the resin material is provided in the first region, the resin material narrower in a third direction orthogonal to the first direction and the second direction than the resin material in the first region is provided or the resin material is not provided in the second region. In the second region, a magnetic material is interposed between the magnetic block and the facing surface of the first conductive portion of the coil conductor.

A DC-DC converter according to one aspect of the present disclosure includes the above inductor.

### BRIEF DESCRIPTION OF THE DRAWINGS

FIG. 1 is a perspective view of an inductor according to one embodiment.

FIG. 2 is an exploded view of the inductor shown in FIG. 1.

FIG. 3 is a side surface view of the magnetic block and the coil conductor shown in FIG. 1.

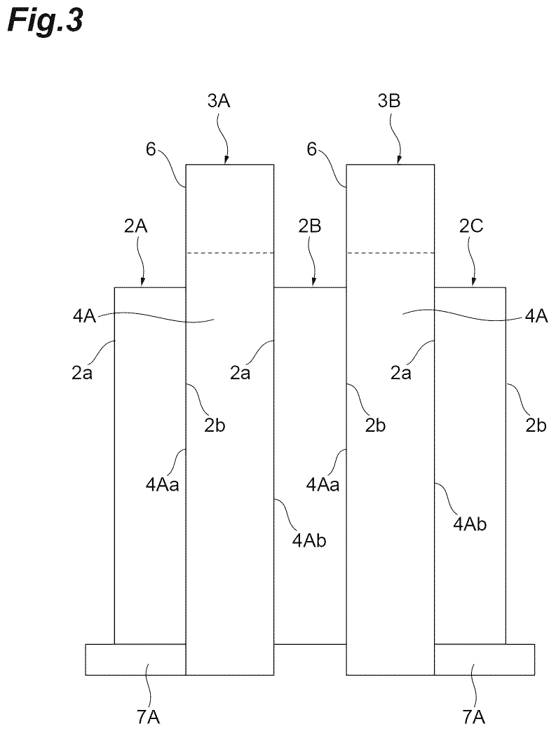

FIG. 4 is a side surface view from the Y direction (on the left) and a side surface view from the X direction (on the right) of the adhesive material in the coil conductor.

FIG. 5 is a cross-sectional view taken along line V-V of the inductor shown in FIG. 1.

FIG. 6 is a circuit diagram of a DC-DC converter where the inductor shown in FIG. 1 is used.

FIG. 7 is a side surface view from the Y direction (on the left) and a side surface view from the X direction (on the right) of the adhesive material in the coil conductor according to an embodiment different from that in FIG. 4.

FIG. 8 is a side surface view from the Y direction (on the left) and a side surface view from the X direction (on the right) of the adhesive material in the coil conductor according to an embodiment different from that in FIG. 4.

### DETAILED DESCRIPTION

The inventors studied on the formation of adhesive material bonding a coil conductor and a magnetic block, and have found that the formation of the adhesive material affects the inductance value, and have newly found a technique capable of increasing the inductance value while stabilizing the inductance value.

An object of one aspect of the present disclosure is to provide an inductor and a DC-DC converter stabilizing and improving an inductance value.

Hereinafter, embodiments of the present disclosure will be described in detail with reference to the accompanying drawings. In the description, the same reference numerals are used for the same elements or elements having the same functions, and redundant description will be omitted.

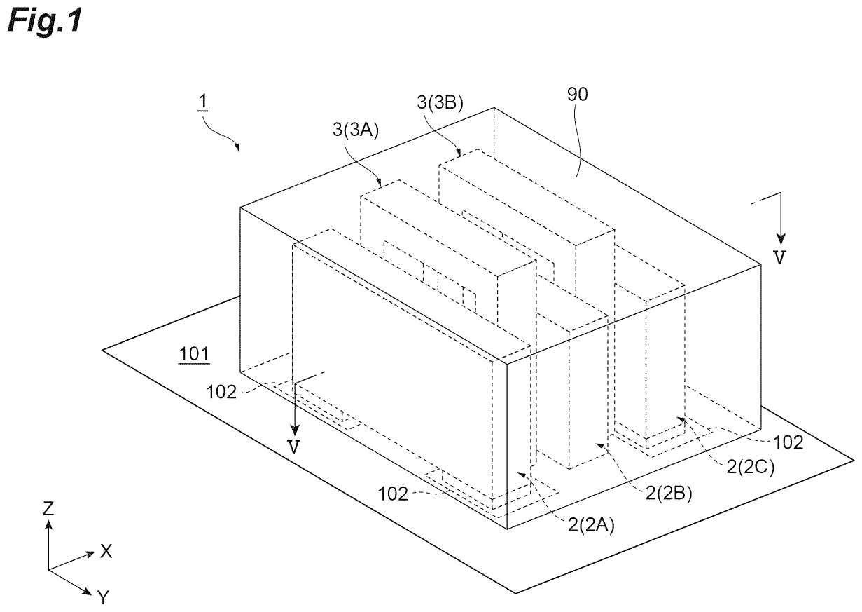

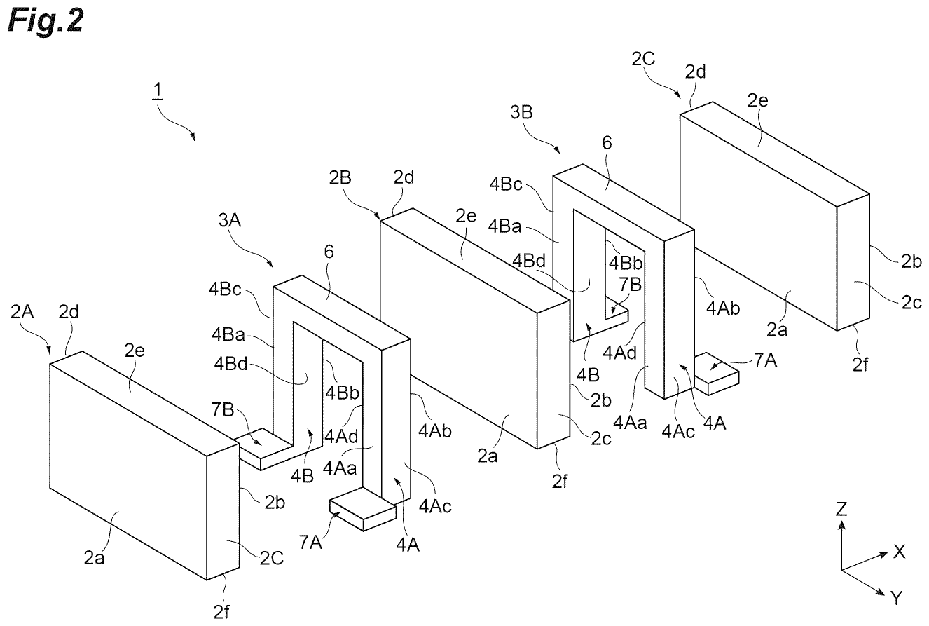

A schematic configuration of a inductor 1 according to one embodiment will be described with reference to FIGS. 1 and 2. FIG. 1 is a perspective view of the inductor 1 in the present embodiment. FIG. 2 is a exploded view of the inductor 1. In FIG. 1, the inductor 1 is mounted on a substrate 101.

The inductor 1 is configured with an element body 90, magnetic blocks 2 and coil conductors 3 provided in the element body 90. The magnetic block 2 as a core and the coil conductor 3 are stacked in the X direction. In the present embodiment, the X direction, the Y direction, and the Z direction are orthogonal to each other. The X direction corresponds to the “first direction” in the claims, the Z direction orthogonal to the X direction corresponds to the “second direction” in the claims, and the Y direction orthogonal to the X direction and the Z direction corresponds to the “third direction” in the claims.

As shown in FIG. 1, the inductor 1 includes the element body 90 having an outer shape of a rectangular parallelepiped shape. In the present embodiment, the outer shape of the element body 90 is configured with three pairs of surfaces facing in the X direction, the Y direction, and the Z direction, respectively. The element body 90 may be configured with magnetic resin. The magnetic resin is a resin containing a magnetic powder. For example, the magnetic resin is a bound powder in which the magnetic powder is bound by a binder resin.

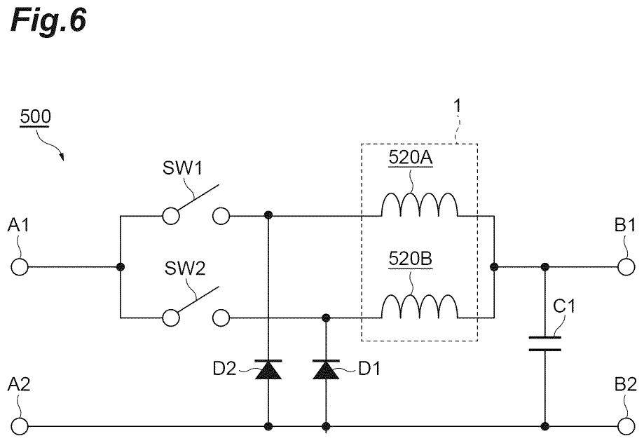

The inductor 1 includes three of the magnetic blocks 2 and two of the coil conductors 3 in the element body 90. Two of the coil conductors 3 (3A and 3B) included in the inductor 1 may be used as chokes in a circuit of a DC-DC converter 500 shown in FIG. 6. The DC-DC converter 500 is a multi-phase converter including a pair of conversion portions of switching elements SW1, SW2, choke coils 520A, 520B, diodes D1 and D2, and these conversion portions are connected in parallel. The inductor 1 may be adopted as each of the choke coils 520A and 520B of each conversion portion. To describe the configuration of the DC-DC converter 500 in more detail, the DC-DC converter 500 includes a pair of input terminals A1 and A2, a pair of output terminals B1 and B2, the switching element SW1 and the choke coil 520A connected in series in this order between the input terminal A1 and the output terminal B1, the switching element SW2 and the choke coil 520B connected in series in this order between the input terminal A1 and the output terminal B1, and a capacitor C1 connected between the output terminal B1 and B2. A circuit consisting of the switching element SW1 and the choke coil 520A and a circuit consisting of the switching element SW2 and the choke coil 520B are connected in parallel between the input terminal A1 and the output terminal B1. The input terminal A2 and the output terminal B2 configure the ground line. The diode D2 is reversely connected between the connection point of the switching element SW1 and the choke coil 520A and the ground line, and the diode D1 is reversely connected between the connection point of the switching element SW2 and the choke coil 520B and the ground line. The switching element SW1 and SW2 are alternately turned on and off by a control circuit (not shown). By configuring the pair of the choke coils 520A and 520B in the DC-DC converter 500 with the pair of coil conductors 3A and 3B of the inductor 1, the number of components configuring the DC-DC converter 500 can be reduced.

The three magnetic blocks 2 consists of a first magnetic block 2A, a second magnetic block 2B, and a third magnetic block 2C. The first magnetic block 2A, the second magnetic block 2B, and the third magnetic block 2C are arranged in this order in a state of facing each other while being spaced apart from each other in the X direction. The magnetic blocks 2 has the shape of a rectangular parallelepiped shape. In the present embodiment, it has a rectangular parallelepiped shape that is flat in the X direction. The magnetic blocks 2 have the same shape. The magnetic block 2 may be configured by a magnetic material, for example, a sintered magnetic core such as MnZn-based ferrite or NiZn-based ferrite, or a laminated magnetic core formed by laminating soft magnetic metal plates. The magnetic permeability of the magnetic block 2 may be 1000 or more. Further, the magnetic blocks 2 may have substantially the same magnetic properties or may have different magnetic properties.

Each of the three magnetic block 2A to 2C has a pair of main surfaces 2a and 2b, a pair of end surfaces 2c and 2d, and a pair of side surfaces 2e and 2f. The pair of main surfaces 2a and 2b face each other in the X direction. The main surface 2a is disposed on the negative side in the X direction, and the main surface 2b is disposed on the positive side in the X direction. The pair of end surfaces 2c and 2d face each other in the Y direction. The end surface 2c is disposed on the positive side in the Y direction, and the end surface 2d is disposed on the negative side in the Y direction. The pair of side surfaces 2e and 2f face each other in the Z direction. The side surface 2e is disposed on the positive side in the Z direction, and the side surface 2f is disposed on the negative side in the Z direction.

As shown in FIG. 1, the magnetic blocks 2A to 2C is disposed at the same position in the Y-Z plane such that the end surfaces and the side surfaces overlap each other when viewed from the X direction. A positional deviation within a range caused by a manufacturing error or the like is included in the “same position”.

Two of the coil conductors 3 consist of a first coil conductor 3A and a second coil conductor 3B. The first coil conductor 3A and the second coil conductor 3B are aligned in the X direction with the second magnetic block 2B interposed therebetween. The first coil conductor 3A is interposed between the first magnetic block 2A and the second magnetic block 2B, and the second coil conductor 3B is interposed between the second magnetic block 2B and the third magnetic block 2C. The material of the coil conductor 3 is configured by, for example, metals selected from Cu, Ag, Au, Al, Ni, Sn, and the like.

The first coil conductor 3A includes a pair of conductive portions 4A and 4B, a connecting portion 6, and a pair of terminal portions 7A and 7B. The pair of conductive portions 4A and 4B correspond to the “first conductive portion” in the claims, and the pair of terminal portions 7A and 7B correspond to the “second conductive portion” in the claims.

Both of the conductive portion 4A and 4B extend in the Z direction and are parallel to each other. The conductive portions 4A and 4B are interposed between the first magnetic block 2A and the second magnetic block 2B in the X direction. The conductive portion 4A is disposed on the positive side in the Y direction, and the conductive portion 4B is disposed on the negative side in the Y direction. The conductive portions 4A and 4B do not have to be parallel to the Z direction as long as they extend along the Z direction.

The conductive portion 4A has a pair of facing surfaces 4Aa and 4Ab and a pair of side surfaces 4Ac and 4Ad. The pair of facing surfaces 4Aa and 4Ab face each other in the X direction. The facing surface 4Aa disposed on the negative side in the X direction faces the first magnetic block 2A in the X direction. The facing surface 4Ab disposed on the positive side in the X direction faces the second magnetic block 2B in the X direction. The side surfaces 4Ac and 4Ad face each other in the Y direction. The side surface 4Ac is disposed on the positive side in the Y direction, and the side surface 4Ad is disposed on the negative side in the Y direction. The conductive portion 4B has a pair of facing surfaces 4Ba and 4Bb and a pair of side surfaces 4Bc and 4Bd. The pair of facing surfaces 4Ba and 4Bb faces each other in the X direction. The facing surface 4Ba disposed on the negative side in the X direction faces the first magnetic block 2A in the X direction. The facing surface 4Bb disposed on the positive side in the X direction faces the second magnetic block 2B in the X direction. The side surfaces 4Bc and 4Bd face each other in the Y direction. The side surface 4Bc is disposed on the negative side in the Y direction, and the side surface 4Bd is disposed on the positive side in the Y direction.

The connecting portion 6 is a member that connects the conductive portion 4A and the conductive portion 4B. The connecting portion 6 is connected to one end (i.e., an end of the positive side in the Z direction) of each of the conductive portions 4A and 4B, and extends in the Y direction. The connecting portion 6 may not be parallel to the Y direction as long as it extends along the Y direction.

The terminal portion 7A is provided at the other end (i.e., an end of the negative side in the Z direction) of the conductive portion 4A and extends to the negative side in the X direction and the positive side in the Y direction. The terminal portion 7A is configured by forming a part near the other end of the conductive portion 4A so as to be wider toward the positive side in the Y direction and bending the wider part toward the negative side in the X direction. The terminal portion 7B is provided at the other end (i.e., an end of the negative side in the Z direction) of the conductive portion 4B and extends to the negative side in the X direction and the negative side in the Y direction. The terminal portion 7B is configured by forming a portion near the other end of the conductive portion 4B so as to be wider toward the negative side in the Y direction and bending the wider part toward the negative side in the X direction. The first magnetic block 2A adjacent to the first coil conductor 3A on the negative side in the X direction is placed on the terminal portions 7A and 7B of the first coil conductor 3A. The terminal portions 7A and 7B are mounted on the land electrodes 102 on the substrate 101 where the inductor 1 is mounted. Thus, the inductor 1 is mounted on the substrate 101.

Similarly to the first coil conductor 3A, the second coil conductor 3B includes the pair of conductive portions 4A and 4B, the connecting portion 6, and the pair of terminal portions 7A and 7B. The second coil conductor 3B is different from the first coil conductor 3A in that the terminal portion 7A extends from the other end of the conductive portion 4A to the positive side in the X direction and the positive side in the Y direction, and the terminal portion 7B extends from the other end of the conductive portion 4B to the positive side in the X direction and the negative side in the Y direction. The third magnetic block 2C adjacent to the second coil conductor 3B on the positive side in the X direction is placed on the terminal portions 7A and the 7B of the second coil conductor 3B. The terminal portions 7A and 7B of the second coil conductor 3B are also mounted on the land electrodes 102 on the substrate 101 where the inductor 1 is mounted.

In each of the terminal portions 7A and 7B of the first coil conductor 3A and the terminal portions 7A and 7B of the second coil conductor 3B, the surface of the negative side in the Z direction is exposed from the element body 90, and the exposed portion is connected to the land electrode 102. In addition, a part of a surface adjacent to the surface on the negative side in the Z direction of the terminal portions 7A and 7B of the first coil conductor 3A and the terminal portions 7A and 7B of the second coil conductor 3B may be exposed from the element body 90.

Adhesive materials 10 (resin material) are interposed between the magnetic blocks 2 and the coil conductors 3, and the magnetic blocks 2 and the coil conductors 3 are adhered to each other by the adhesive materials 10. Specifically, the adhesive material 10 is provided in each of the facing surfaces 4Aa and 4Ab of the conductive portion 4A and the facing surfaces 4Ba and 4Bb of the conductive portion 4B of each of the coil conductors 3. More specifically, the adhesive material 10 is provided in each of facing regions R facing the magnetic block 2 in the facing surfaces 4Aa, 4Ab, 4Ba, and 4Bb. The adhesive material 10 can be provided on the facing region R by a known application technique using a nozzle or the like. The adhesive material 10 may be configured by a material in which a filler is dispersed in a resin. The filler may be made of magnetic material or non-magnetic material.

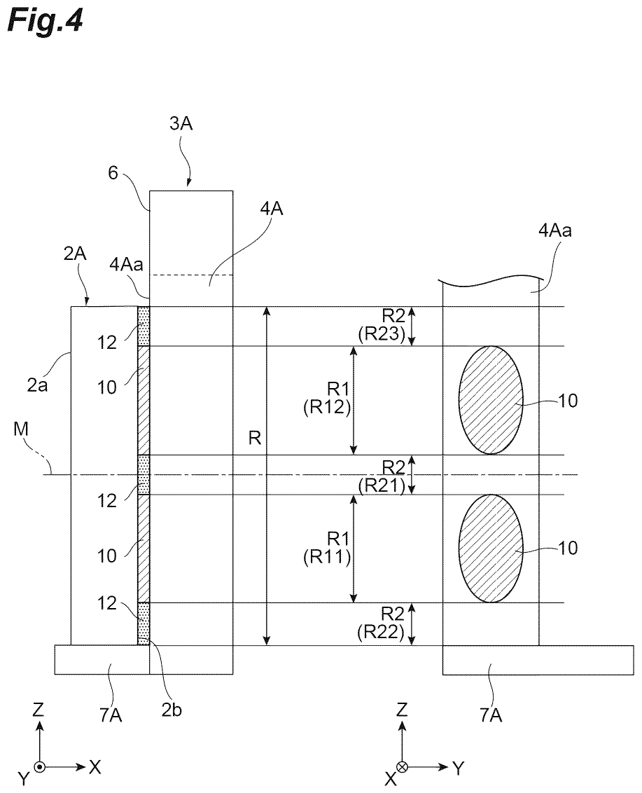

Hereinafter, the adhesive material 10 in the facing region R of the facing surface 4Aa in the conductive portion 4A will be described with reference to FIG. 4. The facing surfaces 4Ab, 4Ba, and 4Bb other than the facing surface 4Aa of the conductive portion 4A are identical or similar to that of the facing surface 4Aa of the conductive portion 4A, and the description thereof will be omitted.

As shown in FIG. 4, the adhesive material 10 is not provided entirely in the facing region R of the facing surface 4Aa, but is provided partially in the facing region R. Specifically, in a side surface view viewed from the Y direction (shown on the left in FIG. 4), the facing region R includes a first region R1 where the adhesive material 10 is provided and a second region R2 where the adhesive material 10 is not provided. In the present embodiment, the first region R1 includes two of first regions R11 and R12 and the second region R2 includes three of second regions R21, R22, and R23. In each of the first regions R1, the adhesive material 10 has an elliptical shape extending in the Z direction. As shown on the right in FIG. 4, when viewed in the X direction, each of the first regions R1 may include a region where the adhesive material 10 is not provided (i.e., an outer region of the ellipse). In each of the second regions R2, the magnetic material 12 is interposed between the magnetic block 2A and the conductive portion 4A of the coil conductor 3A. In the present embodiment, the magnetic material 12 is made of the magnetic resin constituting the element body 90, and flows into each of the second regions R2 when the magnetic block 2 and the coil conductor 3 are integrally molded with the magnetic resin.

The first regions R11 and R12 are separated from each other in the Z direction, the first region R11 is located on the other end side (i.e., the terminal portion 7A side) of the conductive portion 4A, and the first region R12 is located on one end side (i.e., the connecting portion 6 side) of the conductive portion 4A.

The second region R21 is located between the first regions R11 and R12. Further, the second region R21 is located in an intermediate M with regard to the Z direction of the magnetic block 2A facing to where the facing region R of the facing surface 4Aa. The second region R22 is located closer to the other end of the conductive portion 4A than the first region R11. The second region R23 is located closer to the one end of the conductive portion 4A than the first region R12.

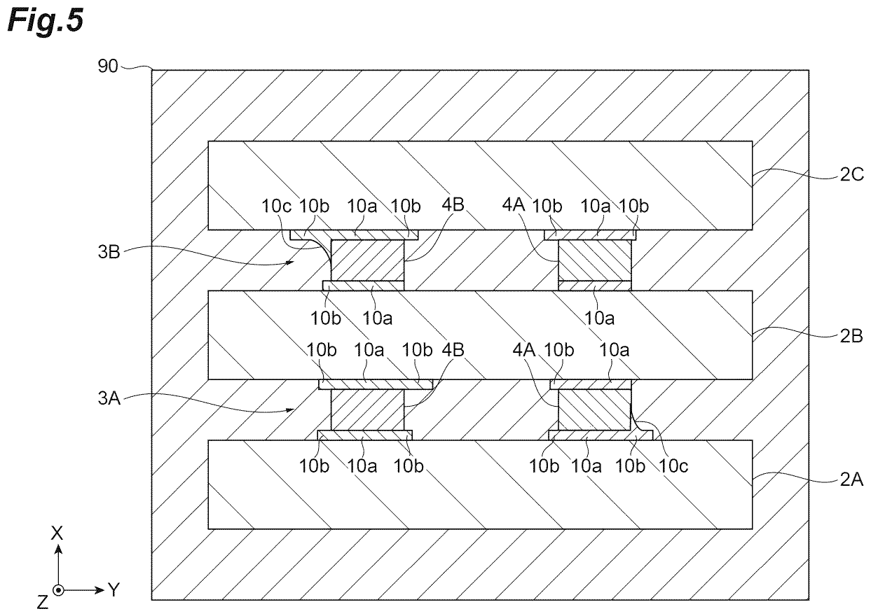

The adhesive material 10 may exist completely within the facing region R of the facing surfaces 4Aa, 4Ab, 4Ba, and 4Bb, or may protrude from the facing region R of the facing surfaces 4Aa, 4Ab, 4Ba, and 4Bb. As shown in FIG. 5, the adhesive material 10 may include, in addition to a first portion 10a interposed between the magnetic block 2 and the facing region R of the facing surface 4Aa, 4Ab, 4Ba, and 4Bb of the conductive portions 4A and 4B of the coil conductor 3, a second portion 10b extending from the first portion 10a and provided in an adjacent region of the region where the magnetic block 2 and the facing region R face. The second portion 10b increases the joint strength between the magnetic block 2 and the resin material constituting the element body 90. The adhesive material 10 may further include a third portion 10c provided on a surface adjacent to the facing surface 4Aa, 4Ab, 4Ba, and 4Bb of the conductive portions 4A and 4B of the coil conductor 3 and connected to the second portion 10b. The third portion 10c may extend from the second portion 10b in a fillet shape. The third portion 10c increases the joint strength between the magnetic block 2 and the coil conductor 3.

In the inductor 1 and the DC-DC converter 500 described above, the leveling of the amount of the adhesive material 10 in the facing regions R of the facing surfaces 4Aa, 4Ab, 4Ba, and 4Bb of the conductive portions 4A and 4B is achieved by receiving a part of the adhesive material 10 of the first region R1 with the second region R2, even when the amount of the adhesive material 10 provided in the first region R1 is excessive. As a result, the relative positional relationship between the magnetic blocks 2 and the conductive portions 4A and 4B of the coil conductors 3 is stabilized, and the inductance value is stabilized. In addition, in the second region R2, the magnetic volume is increased by the magnetic material 12 interposed between the magnetic block 2 and the facing surfaces 4Aa, 4Ab, 4Ba, and 4Bb of the conductive portions 4A and 4B of the coil conductor 3, so that the inductance value is improved.

In the inductor 1, since the facing region R includes a plurality of first regions R11 and R12, the magnetic block 2 and the conductive portions 4A and 4B of the coil conductor 3 support each other at a plurality of regions, so that the magnetic block 2 and the conductive portions 4A and 4B of the coil conductor 3 are less likely to tilt with respect to each other, thereby further stabilizing the relative positional relationship. In particular, as shown in FIG. 4, since the second region R21 is positioned at the intermediate M of the magnetic block 2A and the first regions R11 and R12 are positioned on both sides of the second region R21 in the Z direction, so that the inclination between the magnetic block 2 and the conductive portions 4A and 4B of the coil conductor 3 is further suppressed. The second regions R22 and R23 contribute to the reduction of the amount of the adhesive material 10 to be used, and also contribute to the improvement of the inductance value because the magnetic material 12 exist in the second regions R22 and R23. The first region R12 may be disposed to reach the end of the positive side in the Z direction of the facing region R, and in this case, the second region R23 may be omitted. In addition, the first region R11 may be disposed to reach the end portion of the negative side in the Z direction of the facing region R, and in this case, the second region R22 may be omitted.

The inductor 1 can achieve a high inductance value because the element body 90 sealing the magnetic block 2 and the coil conductor 3 is configured with magnetic resin.

The inductor 1 is not limited to the above-described embodiment, and various modifications can be made without departing from the scope of the present disclosure.

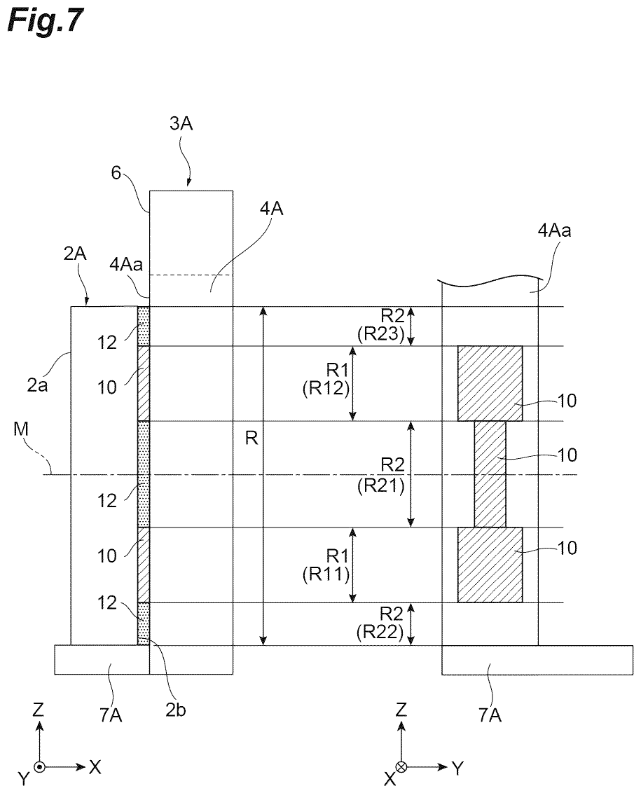

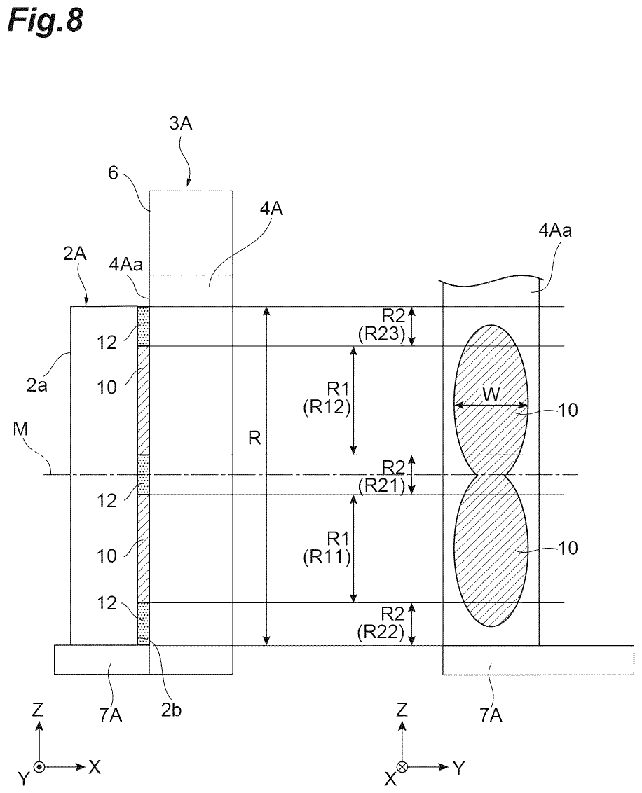

For example, the adhesive material 10 may not be provided in the second region R2, or the adhesive material 10 may be provided in the second region R2 as long as the length in the Y direction (that is, the width) is a narrower width than the adhesive material 10 provided in the first region R1. For example, as shown in FIG. 7, each of the first regions R1 may be provided with the adhesive material 10 having a uniform width (in particular, a rectangular shape), and the second regions R2 may also be provided with an adhesive material having a width narrower than the adhesive material 10 in the first regions R1. In this case, in the facing region R, the adhesive material 10 has an I-shape extending in the Z direction. As shown on the right in FIG. 7, when viewed from the X direction, there is a region in which the adhesive material 10 is not provided (that is, both side regions in the Y direction) in each of the regions R1 and R2, and thus the magnetic material 12 may be interposed in these regions. In addition, as shown in FIG. 8, in a case of a shape in which two of the adhesive material 10 having an elliptical shape are connected to each other in the Z direction, a region where the adhesive material 10 has a wide width can be defined as the first region R1, and a region where the adhesive material 10 has a narrow width can be defined as the second region R2. For example, a certain percentage (for example, 80%) of the width with respect to a maximum width W of the adhesive material 10 is set as a reference value, and if the width is wider than the reference value, it can be set as the first region R1, and if the width is narrower than the reference value, it can be set as the second region R2. In the embodiment shown in FIG. 4, instead of the first region R1 where the adhesive material 10 exists and the second region R2 where the adhesive material 10 does not exist, it can be determined that the first region R1 is a region where the adhesive material 10 is wider than a predetermined value and the second region R2 is a region where the adhesive material 10 is narrower than a predetermined value.

Since the adhesive material 10 is not provided entirely in the facing region R of the facing surface 4Aa, the amount of the adhesive material 10 can be suppressed. The ratio of the surface area of the adhesive material 10 to the surface area of the facing region R is less than 100%, and can be, for example, in the range of 20 to 90%. In addition, it may be in the range of 50% to 70% in view of both improvement of the inductance value and adhesiveness.

When the adhesive material 10 is magnetic, the inductance value is further improved. In addition, when the adhesive material 10 includes a filler, the filler further stabilizes the relative positional relationship between the magnetic block 2 and the conductive portions 4A and 4B of the coil conductor 3. When the average particle size of the filler in the adhesive material 10 is compared with the average particle size of the magnetic powder included in the magnetic material 12 (for example, the magnetic resin of the element body), in a case where the average particle size of the magnetic powder included in the magnetic material 12 is smaller than the average particle size of the filler of the adhesive material 10, the eddy-current loss in the second region R2 can be reduced.

Further, the number of the first region R1 in each of the facing regions R may be one or more (for example, three or more). The number of the second region R2 in each of the facing regions R may be one or more.

What is claimed is:

1. An inductor comprising:
a magnetic block;
a coil conductor aligned with the magnetic block in a first direction and extending in a second direction orthogonal to the first direction and including a first conductive portion having a facing surface including a facing region facing the magnetic block in the first direction; and
a resin material interposed between the magnetic block and the facing region of the facing surface of the first conductive portion of the coil conductor;
wherein the facing region of the facing surface of the first conductive portion includes a first region and a second region, the resin material is provided in the first region, the resin material narrower in a third direction orthogonal to the first direction and the second direction than the resin material in the first region is provided or the resin material is not provided in the second region, and
wherein, in the second region, a magnetic material is interposed between the magnetic block and the facing surface of the first conductive portion of the coil conductor.

2. The inductor according to claim 1, further comprising an element body configured with magnetic resin, at least a part of the magnetic block, at least a part of the coil conductor, and the resin material are disposed in the element body,
wherein the magnetic material is the magnetic resin configuring the element body.

3. The inductor according to claim 1, wherein the facing region of the facing surface of the first conductive portion includes a plurality of the first region arranged in the second direction, and the second region is located between the first regions adjacent to each other in the second direction.

4. The inductor according to claim 3, wherein the second region is located in the middle of the magnetic block facing the facing region of the facing surface with respect to the second direction.

5. The inductor according to claim 1, wherein the coil conductor further includes a second conductive portion connected to one end of the first conductive portion and extending from the one end in the first direction, wherein the second region is located closer to the other end side of the first conductive portion than the first region close to the other end side of the first conductive portion.

6. The inductor according to claim 5, wherein the facing region of the facing surface of the first conductive portion further includes the second region located closer to the one end of the first conductive portion than the first region closer to the one end of the first conductive portion.

7. The inductor according to claim 1, wherein the resin material includes a first portion interposed between the magnetic block and the facing region of the facing surface of the first conductive portion of the coil conductor, and a second portion extending from the first portion and provided on an adjacent region of a region of the magnetic block facing the facing region.

8. The inductor according to claim 7, wherein the resin material further includes a third portion provided on a surface adjacent to the facing surface of the first conductive portion of the coil conductor and connected to the second portion.

9. The inductor according to claim 1, wherein the resin material includes a filler.

10. The inductor according to claim 9, wherein the filler is made of magnetic material.

11. The inductor according to claim 9, wherein the magnetic material is magnetic resin including a magnetic powder,
wherein an average particle size of the magnetic powder of the magnetic resin is smaller than an average particle size of the filler in the resin material.

12. A DC-DC converter comprising the inductor according to claim 1.
